(19) United States
(12) Patent Application Publication
(10) Pub. No.: US 2008/0185311 A1
(43) Pub. Date: Aug. 7, 2008

(54) Rotationally molded plastic refuse container with microbial inhibiting inner surface and method

(75) Inventors: Richard A. Maggio, Laguna Hills, CA (US); Ronald C. Pearson, San Clemente, CA (US)

Correspondence Address: COHEN & GRIGSBY, P.C., 11 STANWIX STREET, 15TH FLOOR, PITTSBURGH, PA, 15222, US

(73) Assignee: Global Distributors LLC

(21) Appl. No.: 11/580,680

(22) Filed: Oct. 13, 2006

(51) Int. Cl. B65D 25/14; B28B 1/20

(52) U.S. Cl. 206/524.2; 264/311; 220/62.22

(57) ABSTRACT

Rotationally molded plastic refuse container with an inner lining formed with an antimicrobial compound, such as silver based biocide, and method of molding the same.

### FIELD OF THE INVENTION

This invention relates to rotationally molded plastic containers, particularly for containing waste products with a bacteria, fungi and algae growth inhibiting inner surface.

### BACKGROUND OF THE INVENTION

A rotationally molded large capacity waste container or dumpster for industrial and commercial use adapted to be lifted and emptied by the lifting prongs carried by waste transport trucks, is described in U.S. patent application Ser. No. 11/060,940, filed Feb. 18, 2005, entitled MOLDED PLASTIC WASTE CONTAINER WITH INTEGRAL SIDE CHANNELS FOR RECEIVING LIFTING PRONGS AND METHOD (“'940 application”), the contents of which are incorporated herein by reference. Smaller rotationally molded waster containers designed for curbside residential use are described in U.S. Pat. No. 5,922,267 (“'267 patent”).

Rotational molding involves a process for producing generally hollow, seamless plastic products. Its greatest use has been for thermoplastic materials in which a powder or liquid polymer is placed in a mold with the mold being heated and rotated simultaneously about two perpendicular axes, i.e., biaxially. Polyethylene or polypropylene are the most common thermoplastic materials in use.

When using a powdered (or pellet) material, the powder, in coming into contact with the heated rotating mold surface, melts and adheres thereto. As the mold continues to rotate the material continuously coats the heated mold surface to form a homogenous layer of uniform thickness. The mold is then cooled by air or water and opened to allow the part to be removed.

One problem with refuse containers, whether commercial or residential, involves the odor associated with the build-up of organisms such as bacteria, fungus and algae on the inner surfaces of the refuse containing compartment. Silver based biocides, which produce free silver ions that bind to or react with bacteria and other microbe cells to inhibit their replication/growth have been used as an additive to some plastic products, particularly in the medical filed. See the website www.bpf.co.uk/bpfindustry/plastics_additives_antimicrobials.cfm. However, silver based biocide reagents are relatively expensive and it may not be practical, from a cost/utility standpoint, to incorporate such reagents into the entire polymer composition used to form large refuse containers. We have found that the use of such reagents when mixed with the plastic material, such as polyethylene, generally in powdered form, to provide an inner surface of the compartment of a refuse container, is not only economically feasible, but results in greatly mitigating bacteria, fungus and algae growth and the odor which often results from the growth of such microbes.

### SUMMARY OF THE INVENTION

A rotationally molded plastic refuse container in accordance with the present invention includes a material carrying compartment having side walls extending upwardly from a bottom wall to an open top, the inner surface of the bottom and side walls being formed with an antimicrobial compound (e.g., silver biocide) effective to inhibit bacteria growth.

With respect to the method of manufacturing the novel refuse container, a mold is provided which has an enclosed interior space defining a compartment forming section and a cover section. An auxiliary material dispenser or drop box is secured on the outside of the cover section and includes a hopper a valve and an outlet. The outlet is in fluid communication with the compartment forming section when the mold is assembled. The valve is arranged to drop the hopper contents into the compartment forming section when actuated. A first predetermined quantity of powdered/molten plastic material, such as polyethylene, is placed in the compartment section of the mold. A second predetermined quantity of the powdered/molten material and a third predetermined quantity of an antimicrobial reagent or compound (e.g., in pellet or powder form) is placed in the hopper.

The mold is then biaxially rotated and heated to allow the plastic material within the compartment section to flow over and progressively adhere in successive layers to the mold surface forming the outer portion of the compartment. The dispensing or hopper valve is then opened and the mold is continually heated and biaxially rotated to form the inner portion of the compartment with a mixture of the plastic and antimicrobial material. As a result, the inner surface of the refuse container contains a sufficient amount of antimicrobial reagent to inhibit the growth of bacteria, fungi, etc. While the entire container may be molded with a mixture of the plastic and antimicrobial reagent material it is preferred to form only the inner surface with such a mixture for economic reasons.

### BRIEF DESCRIPTION OF THE DRAWINGS

FIG. 1 is a perspective view of a mold for manufacturing a commercial refuse container with the rotational molding process including an auxiliary material dispenser mounted on the mold cover;

FIG. 2 is an enlarged broken away view of the auxiliary material dispenser showing it's internally located material reservoir outlet and valve;

FIG. 3 is a block diagram of a remotely located controller system for actuating the valve in the auxiliary material dispenser; and

FIG. 4 is a perspective view of a finished refuse container;

FIGS. 5 and 6 are a broken away cross-sectional views of a portion of a side wall of the compartment showing the inner surface formed with an antimicrobial reagent.

### DESCRIPTION OF THE PREFERRED EMBODIMENT

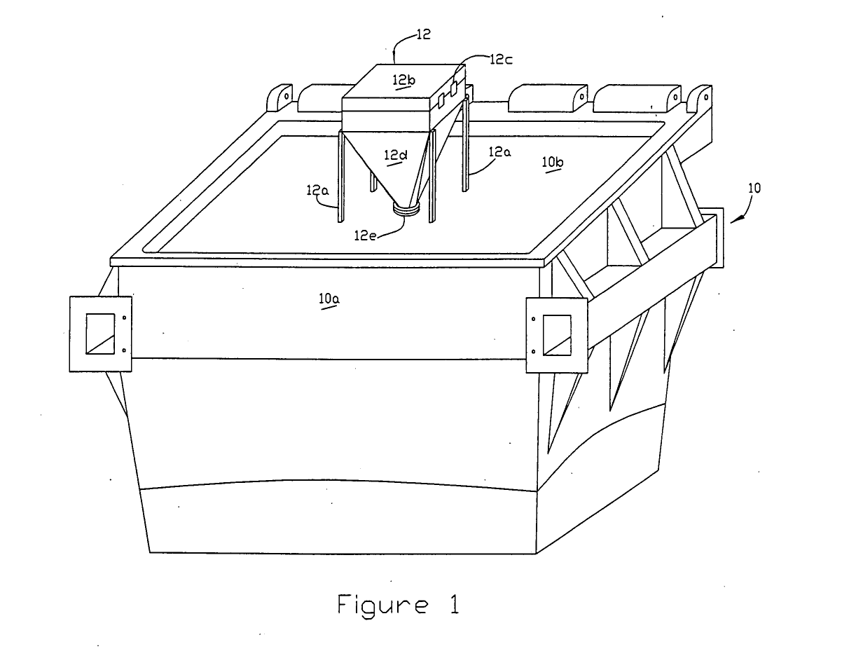

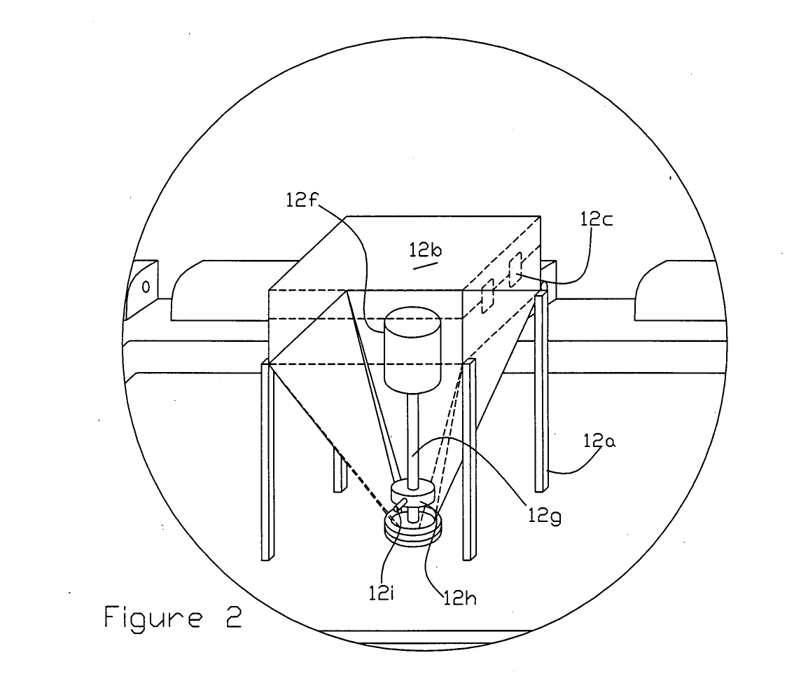

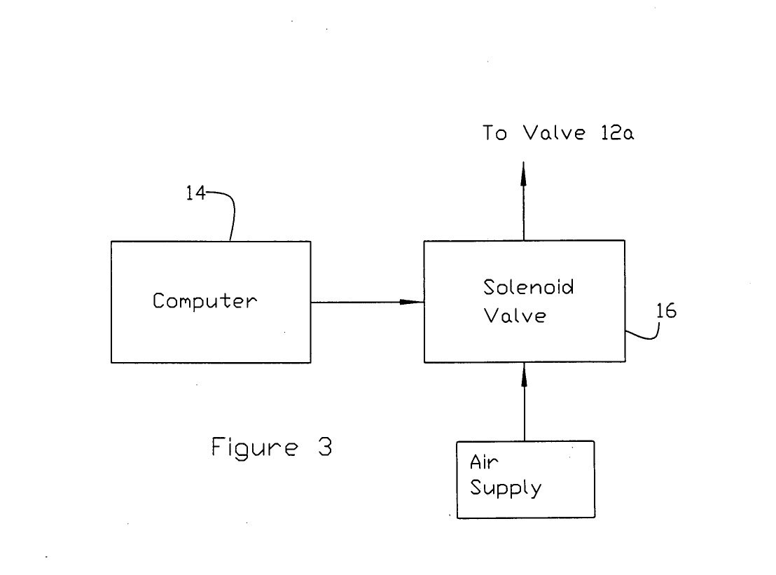

Referring now to FIG. 1 a mold 10 for rotomolding a commercial refuse container includes a compartment forming section 10a and a cover section 10b. For a more detailed description of the basic mold see the '940 application and more specifically FIG. 29 and the description of the mold and molding process.

An auxiliary material dispenser or drop box 12 is secured over the cover section 10b of the mold via legs 12a and bolts (not shown). The drop box 12 includes a cover 12b mounted on hinges 12c, a housing 12d terminating at its lower end in a collar 12e. An internally located auxiliary material reservoir or hopper 12f is in fluid communication with the interior of the mold via tube 12g and an opening in the mold cover section (not shown). A pneumatically operated valve 12h is arranged, when actuated via fluid pressure in line 12i, to allow the reservoir or hopper contents to pass into the mold interior. An externally located computer 14, operating a solenoid valve 16, serves to connect a pressurized air source to the pneumatic valve 12h, via a pneumatic line (not shown), extending through one of the axles which supports the mold in the heating chamber. Insulating materials within the housing (not shown) effectively isolates the hopper 12f from the heat surrounding the mold and housing during the molding process.

In accordance with the method, a first predetermined quantity of plastic material such as polyethylene in powdered or pellet form is placed in the compartment forming section of the mold while a second predetermined quantity of the plastic material and a third predetermined quantity of an antimicrobial reagent are placed in the hopper 12f before or after the mold cover section has been secured to the compartment forming section. It should be noted that the ingredients in the hopper are mixed.

The assembled mold is then placed in a heating chamber and biaxially rotated and heated to allow successive layers of the plastic to form an outer portion of the refuse container compartment. The dispenser valve 12h is then opened via the computer 14 and solenoid valve 16. Preferably, the computer is programmed to open the dispenser valve a preset time after the molding operation starts.

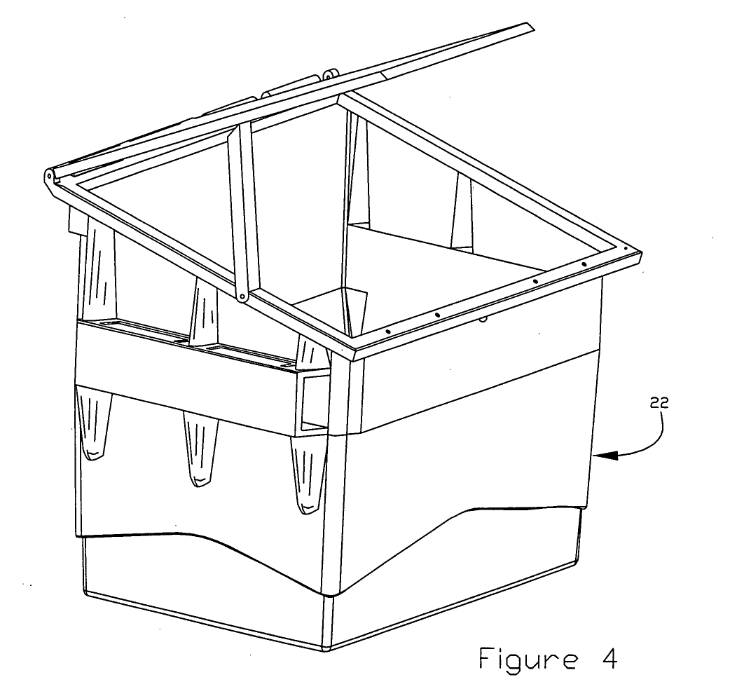

The mixture of plastic material and antimicrobial reagent form an inner portion including the inner surface of the finished container compartment. A finished refuse container 17 is illustrated in FIG. 4 which, appearance wise, is identical to the container shown in FIG. 22 of the '940 application.

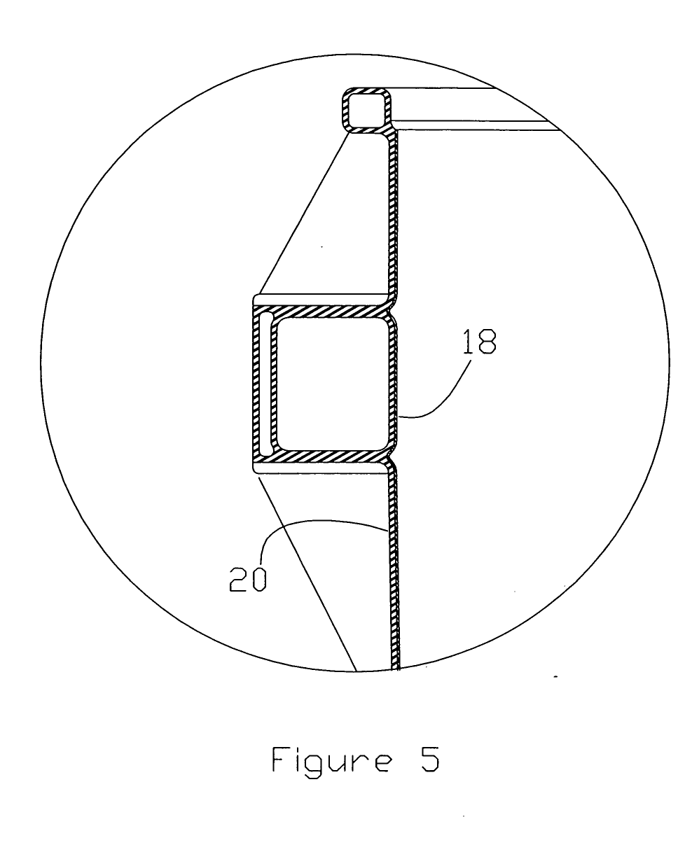

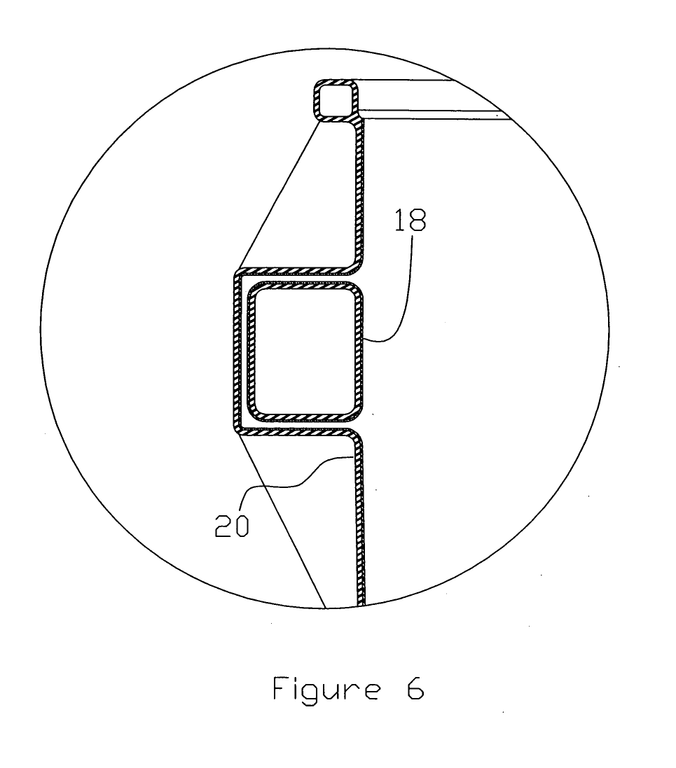

FIGS. 5 and 6 are cross-sectional broken away views of the refuse container, similar to FIGS. 25 and 26 of the '940 application, illustrating the inner portion or lining 18 formed on the outer wall portion 20 of the compartment. It should be noted, that although not shown for purposes of clarity, a small layer of the hopper mixture will be formed on the inside of the rim (both figures) and around the pockets in FIG. 4 until the gaps bridge over as will be apparent to those skilled in the art. The thicknesses of layers 18 and 20 are preferably within the ranges of about 0.03″ and 0.625″, respectively, and most preferably within the ranges of about 0.065″ and 0.500″.

By way of example we have found that the antimicrobial reagent may comprise less than 1% or even less than ½% of the total mixture used to mold the refuse container. By way of a specific example we have found that for a 3 yd³ container a quantity of 175 pounds of polyethylene in the compartment forming mold section, 50 pounds of polyethylene along with 9 ounces of antimicrobial reagent provided by Agion Technologies, Inc. of Wakefield, Me. placed in the hopper provide a structurally sound container with sufficient silver ions available on the inner surface to inhibit the growth of bacteria greatly reducing the odor often associated with refuse containers.

It is to be noted that the drop box is an off the shelf item and has been used to add a different color and/or texturing layer to the inside of rotationally molded articles. By the same token applicants also acknowledge that antimicrobial reagents have been used in molding various plastic articles, primarily for medical products.

While the drawings illustrate a large commercial refuse container, smaller residential or curb side containers can be molded with the same inner layer containing an antimicrobial reagent.

Applicants have discovered that it is economically feasible and practical to use an antimicrobial reagent to form the inner layers of a refuse container and thereby providing a relatively odor free and superior refuse container.

An improved odor inhibiting refuse container and method of molding the same has been described. Skilled artisans will undoubtedly conceive of modifications to the container and method without departing from the spirit and scope of our invention as defined in the appended claims.

What is claimed is:

1. A rotationally molded plastic refuse container comprising a material carrying compartment having side walls extending upwardly from a bottom wall to an open top, the side and bottom walls having an inner and outer surface, the inner surface of the bottom and side walls being formed with an antimicrobial compound effective to inhibit bacteria growth.

2. The refuse container of claim 1 wherein the antimicrobial compound is a silver biocide.

3. The refuse container of claim 2 wherein the antimicrobial reagent constitutes less than 1% by weight of the total plastic used to mold the container.

4. The refuse container of claim 3 wherein the antimicrobial reagent constitutes less than ½% by weight of the total plastic used to mold the container.

5. A method of molding a plastic waste container defining a material holding compartment having a bottom and side walls extending from the bottom wall to an open top comprising:
providing a mold having an interior space defining a compartment forming section and cover section extending over the compartment forming section;
positioning an auxiliary material dispenser on the mold above the cover section, the dispenser having a hopper, an outlet in fluid communication with the compartment forming section, and a valve located between the hopper and the outlet, the valve being arranged when actuated to discharge the contents of the hopper into the compartment forming section;
placing a first predetermined quantity of powdered/molten plastic material in the compartment section;
placing a second predetermined quantity of the powdered/molten material and a third predetermined quantity of an antimicrobial reagent in the hopper;
biaxially rotating and heating the mold to allow the plastic material to flow over and progressively adhere in successive layers to the mold surface to form the compartment with an outer homogenous layer of material; and
opening the valve to allow the hopper's contents to enter the compartment section and continually biaxially rotating and heating the mold to allow the plastic material and antimicrobial agents from the hopper to form an inner homogenous layer adhering to the outer layer of the compartment.

6. The method of claim 5 wherein the compartment inner and outer layers are within the thickness ranges of 0.03″ and 0.625″, respectively.

7. The method of claim 6 wherein the compartment inner and outer layers are within the thickness ranges of 0.065″ and 0.500″, respectively

8. The method of claim 5 wherein the antimicrobial reagent constitutes less than 1% of the total plastic material used in the process.

9. The method of claim 8 wherein the antimicrobial reagent is silver biocide.
